(19) United States
(12) Patent Application Publication
(10) Pub. No.: US 2011/0250783 A1
(43) Pub. Date: Oct. 13, 2011

(54) CABLE ASSEMBLY WITH IMPROVED TERMINATING MEANS AND METHOD OF MAKING THE SAME

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/078,008

(22) Filed: Apr. 1, 2011

(30) Foreign Application Priority Data
Apr. 7, 2010 (CN) 201010140364.1

(51) Int. Cl. H01R 4/24; H01R 43/00; H01R 24/00

(52) U.S. Cl. 439/404; 439/660; 29/857

(57) ABSTRACT

A cable assembly (1000) includes an insulative housing (11); a plurality of contacts (13) mounted to the insulative housing, and each of the contacts having a retention portion, a mating portion and a tail portion, said tail portion (133) defining a longitudinal slot (1331); a cable (14) having an insulative jacket and a plurality of wires enclosed by the insulative jacket, partial of the insulative jacket of a front segment of the cable stripped off to expose the wires outside; a back cover (12) assembled to the insulative housing to urge the wires into the longitudinal slots and the wires bent to round the back cover and the cable extending along a longitudinal direction.

### BACKGROUND OF THE INVENTION

1. Field of the Invention

The present invention relates to a cable assembly, especially to a cable assembly with improved terminating means.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a plurality of contacts mounted to the insulative housing, and each of the contacts having a retention portion, a mating portion and a tail portion, said tail portion defining a longitudinal slot; a cable having an insulative jacket and a plurality of wires enclosed by the insulative jacket, partial of the insulative jacket of a front segment of the cable stripped off to expose the wires outside; a back cover assembled to the insulative housing to urge the wires into the longitudinal slots and the wires bent to round the back cover and the cable extending along a longitudinal direction.

Accordingly, to achieve above-mentioned object, a method of making a cable assembly comprises steps of: providing an insulative housing; providing a plurality of contacts and mounting the contacts to the insulative housing, with tail portions of the contacts disposed behind the insulative housing and each of the tail portions defining a longitudinal slot; providing a cable which has a number of wires and an insulative jacket enclosing the wires, removing partial of insulative jacket off to expose the wires outside;

disposing the wires on the tail portions of the contacts and perpendicular to the longitudinal slots, respectively; providing a back cover and mounting the back cover to the insulative housing to press the wires into the longitudinal slots, respectively; bending the wires to bypass the back cover and disposing the cable behind the back cover and extending along a longitudinal direction.

The detailed features of the present invention will be apparent in the detailed description with appropriate reference to the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly in FIG. 1;

FIG. 3 is similar to FIG. 2, but viewed from other aspect;

FIG. 4 is a partial assembled perspective view of the cable assembly, with a back cover separated from a housing of the cable assembly; and

FIG. 5 is a cross-section view of the FIG. 1 taken along a line 5-5.

### DETAILED DESCRIPTION OF THE INVENTION

Reference will now be made in detail to the preferred embodiment of the present invention.

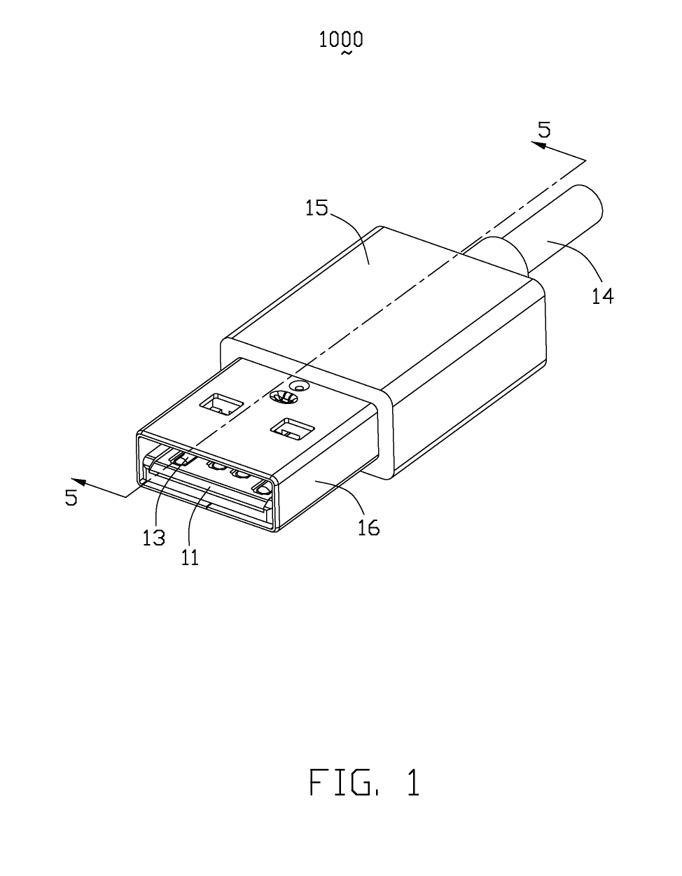

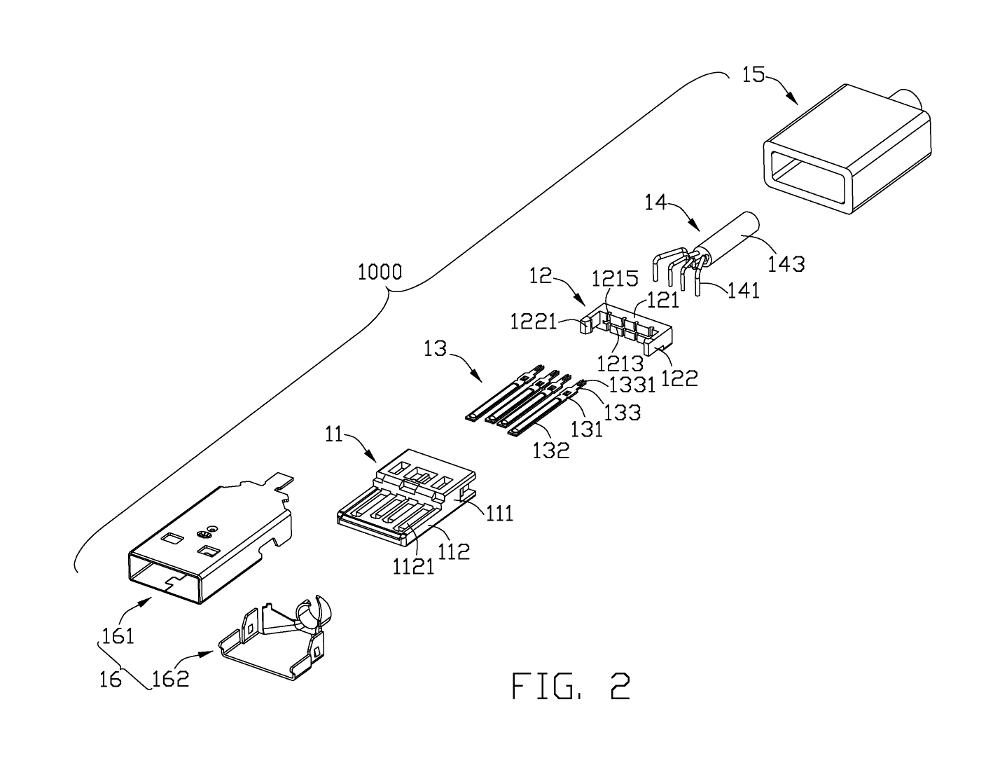

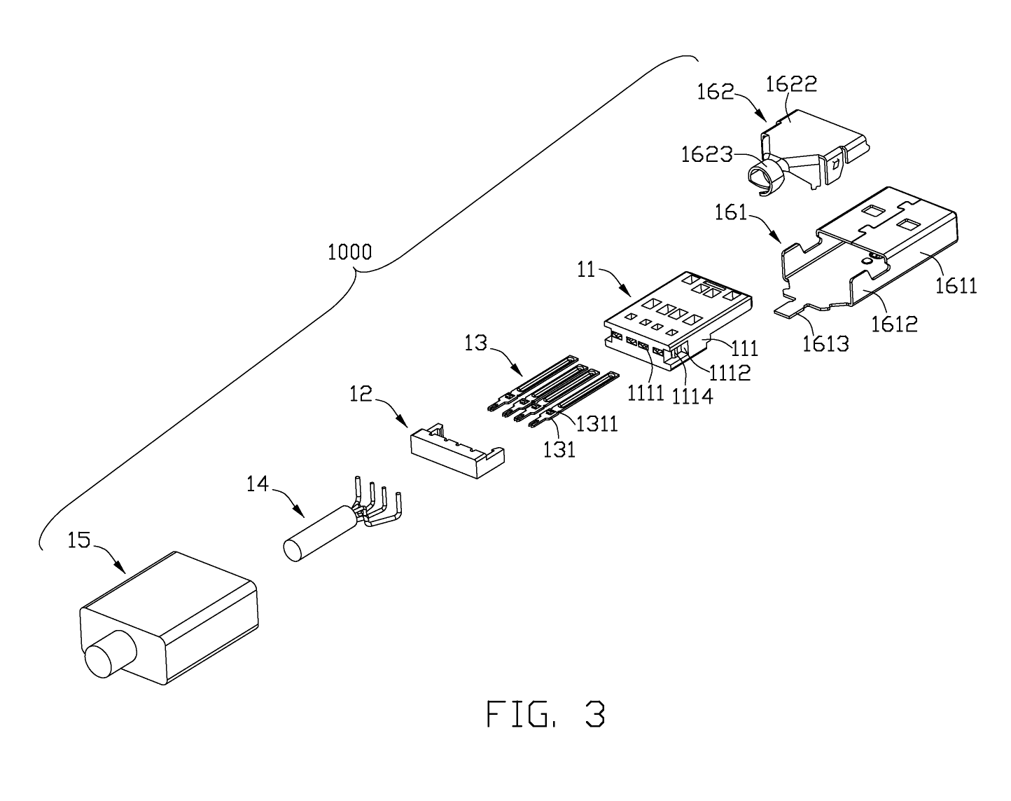

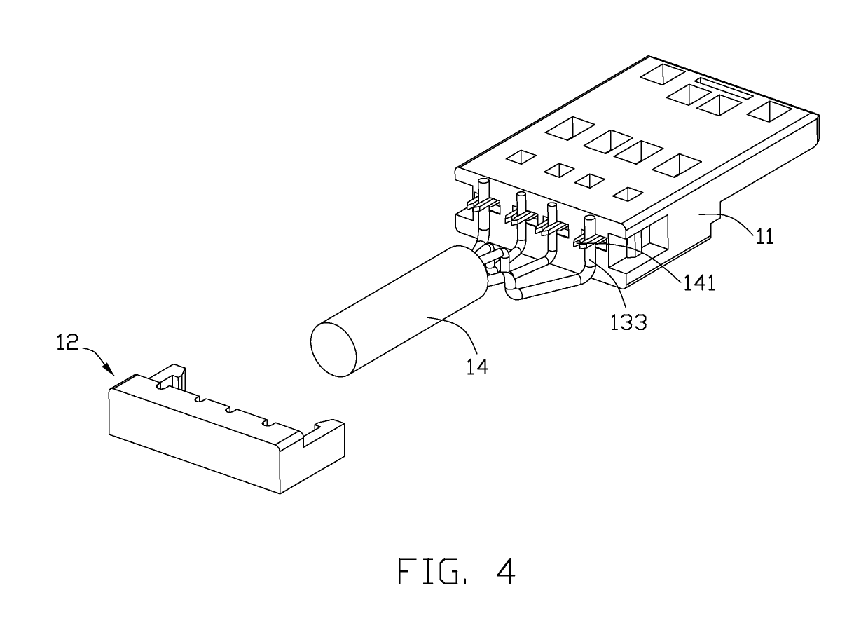

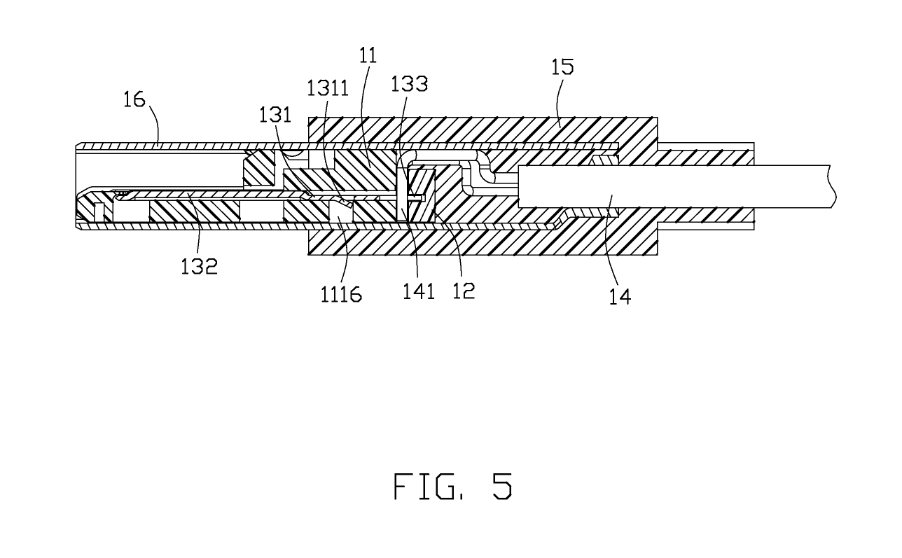

Referring to FIGS. 1-5, a cable assembly 1000 in accordance with the present invention is compatible with Universal Serial Bus (USB). The cable assembly 1000 includes an insulative housing 11, a back cover 12, a plurality of contacts 13, a cable 14, an insulative cover 15 and a metallic shell 16.

The insulative housing 11 has a base portion 111 and a tongue portion 112 extending forwardly from the base portion 111. The base portion 11 is thicker than the tongue portion 112. There are a number of slots 1111 defined in the base portion 111 and extending along a front-back-direction. Also, a number of grooves 1121 are located in a top side of the tongue portion 112 and align with the slots 1111, respectively. Both the slots 1111 and the grooves 1121 are arranged in a row along a transversal direction. There are two recesses 1112 defined at lateral sides of a back segment of the base portion 111, and a protrusion 1114 is located in the recess 1112. A number of through holes 1116 are defined in a bottom side of the base portion 111 and communicate with the slots 1111, respectively.

The back cover 12 includes a main portion 121 and two locking arms 122 extending forwardly from lateral sides of the main portion 121. There is a hooking portion 1221 formed at a front end of each locking arm 122. There is a transversal slot 1213 defined in a front side of the main portion 121. The transversal slot 1213 is located at middle portion of the front side of the main portion 121. A number of vertical slots 1215 are located at the front side of the main portion 121. The vertical slots 1215 are spaced apart from each other along the transversal direction and perpendicular to the transversal slot 1213. Also, the vertical slots 1215 cross with the transversal slot 1213.

There are four contacts 13 in the present embodiment. Each contact 13 has a retention portion 131, a mating portion 132 extending forwardly from the retention portion 131 and a tail portion 133 extending backwardly from the retention portion 131. A tab 1311 projects downwardly and backwardly from the retention portion 131. There is a longitudinal slot 1331 located in the tail portion 133. The contacts 12 are assembled to the insulative housing 11 along the longitudinal direction, with the mating portions 132 accommodated in the grooves 1121, the retention portions received in the slots 1111 and the tail portions 133 are disposed behind the insulative housing 11. In addition, the tab 1311 locks into the corresponding through hole 1116.

The cable 14 is a round type cable, which includes four wires 141 insulated from each other and an insulative jacket 143 enclosing the metallic braiding 142. Each wire 141 has an inner conductor with a layer of outer insulator.

The metallic shell 16 includes a first shell 161 and a second shell 162 assembled together along the vertical direction. The first shell 161 has a rectangular shaped frame portion 1611, a U-shaped engaging portion 1612 extending backwardly from the frame portion 1611 and a piece 1613 connected to the engaging portion 1612. The second shell 162 has an inverted U-shaped engaging portion 1622 and a cable holder 1623 projecting backwardly from the engaging portion 1622.

When assembly, a portion of insulative jacket 143 of a front segment of the cable is stripped off to expose the wires 141 outside, the wires 141 are respectively placed on ends of the tail portions 133 and disposed perpendicular to the longitudinal slots 1331 of the tail portions 133. The back cover 12 is mounted to the insulative housing 11, with the wires 141 aligning with the vertical slots 1215, respectively, and the back cover 12 is pushed toward the insulative housing 11 to urge the wires 141 into the longitudinal slots 1331. The ends of the tail portions 133 are inserted into the longitudinal slot 1213 of the main portion 121. The main portion 121 presses onto the base portion 111 to sandwiched the wires 141 therebetween. The two locking arms 122 lock into the recesses 1112 of the base portion 111, with the hooking portion 1221 engaging with the protrusion 1114. Therefore, the contacts 13 are mechanically and electrically connected with the wires 141.

The insulative housing 11 is mounted into the frame portion 1611 of the first shell 161, the back cover 12 mounted to the U-shaped engaging portion 1612, and the wires 143 are bent about ninety degrees to bypass/round the main portion 121 of the back cover 12 and the cable 14 extends along the longitudinal direction. The second shell 162 is assembled to the first shell 161, with the two engaging portions 1612, 1622 combined together, the cable holder 1623 crimped to the cable 14 and the piece 1613. The insulative cover 15 is attached to the metallic shell 16 and the cable 14 adjacent to the metallic shell 16 by over molding process or assembling process.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a plurality of contacts mounted to the insulative housing, and each of the contacts having a retention portion, a mating portion and a tail portion, said tail portion defining a longitudinal slot;
a cable having an insulative jacket and a plurality of wires enclosed by the insulative jacket, partial of the insulative jacket of a front segment of the cable stripped off to expose the wires outside;
a back cover assembled to the insulative housing to urge the wires into the longitudinal slots and the wires bent to round the back cover and the cable extending along a longitudinal direction.

2. The cable assembly as claimed in claim 1, wherein the back cover includes a main portion and two latching arms extending forwardly from lateral sides of the main portion, and there are two recesses defined in lateral sides of a back segment of the insulative housing to accommodate the two latching arms, respectively.

3. The cable assembly as claimed in claim 2, wherein there is a hook formed at a front end of the latching arm, and there is a protrusion formed in the recess and latching with the hook.

4. The cable assembly as claimed in claim 2, wherein the main portion of the back cover defines a transversal slot to receive ends of the tail portions.

5. The cable assembly as claimed in claim 4, wherein the main portion of the back cover defines a plurality of vertical slots arranged in a row along a transversal direction, and the wires align with the vertical slots, respectively.

6. The cable assembly as claimed in claim 5, wherein the wires are sandwiched between the main portion of the back cover and a back side of the insulative housing.

7. The cable assembly as claimed in claim 1, wherein the insulative housing has a base portion and tongue extending forwardly from the base portion, and the base portion is thicker than the tongue portion.

8. The cable assembly as claimed in claim 7, wherein there are a number of slots defined inside the base portion to receive the retention portions of the contacts, and there are a number of grooves located in a top side of the tongue portion to accommodate the mating portions of the contacts.

9. The cable assembly as claimed in claim 1, further comprising a metallic shell.

10. The cable assembly as claimed in claim 9, wherein the metallic shell includes a first shell and which has a rectangular shaped frame to enclose the insulative housing and a U-shaped engaging portion to accommodate the back cover.

11. The cable assembly as claimed in claim 10, wherein the metallic shell further has a second shell having an inverted U-shaped engaging portion combined with the U-shaped engaging portion of the first shell and a cable holder connected to the inverted U-shaped engaging portion and crimped to the cable.

12. A method of making a cable assembly comprising steps of:
providing an insulative housing;
providing a plurality of contacts and mounting the contacts to the insulative housing, with tail portions of the contacts disposed behind the insulative housing and each of the tail portions defining a longitudinal slot;
providing a cable which has a number of wires and an insulative jacket enclosing the wires, removing partial of insulative jacket off to expose the wires outside;
disposing the wires on the tail portions of the contacts and perpendicular to the longitudinal slots, respectively;
providing a back cover and mounting the back cover to the insulative housing to press the wires into the longitudinal slots, respectively;
bending the wires to bypass the back cover and disposing the cable behind the back cover and extending along a longitudinal direction.

13. The method of making the cable assembly as claimed in claim 12, further comprising a step to providing a metallic shell and assembling the insulative housing and the back cover to the shell.

14. The method of making the cable assembly as claimed in claim 13, wherein the metallic shell has a cable holder crimped to the cable.

15. The method of making the assembly as claimed in claim 14, further comprising a step of providing an insulative cover attached to the metallic shell and the cable.

16. An electrical connector assembly comprising:
an insulative housing defining a front mating port and a rear mounting port opposite to each other in a front-to-back direction;
a plurality of contacts commonly disposed in the housing along a longitudinal direction perpendicular to said front-to-back direction, each of said contacts defining a front mating section located in the front mating port and a rear mounting section located in the mounting port, the rear mounting section defining an IDC (Insulative Displacement Contact) structure;
a cable including a plurality of wires located behind the housing with the IDC structures of the contacts piercing into front end portions of the wires, respectively;
a spacer attached to the housing around the mounting port and cooperating with the housing to sandwich therebetween in said front-to-back direction the corresponding front end portions which extend in a transverse direction perpendicular to both said the front-to-back direction and said longitudinal direction, remaining portions of the wires extending initially along exterior surfaces of the spacer and eventually in said front-to-back direction behind the spacer;
a metallic shell enclosing the housing and a front portion of the cable; and
an overmolded insulator covering a rear portion of the shell and a portion of the cable behind the shell.

17. The electrical connector assembly as claimed in claim 16, wherein the shell includes two parts clamped to each other and grasping the front portion of the cable.

18. The electrical connector assembly as claimed in claim 16, wherein the insulator fills a space in the shell behind the spacer.
